(19) United States
(12) Patent Application Publication
(10) Pub. No.: US 2023/0212847 A1
(43) Pub. Date: Jul. 6, 2023

(54) Soil Absorption System (SAS)

(71) Applicant: David A. Schofield, Wayland, MA (US)

(72) Inventor: David A. Schofield, Wayland, MA (US)

(21) Appl. No.: 18/093,177

(22) Filed: Jan. 4, 2023

Related U.S. Application Data
(60) Provisional application No. 63/296,698, filed on Jan. 5, 2022.

(51) Int. Cl. E03F 1/00; C02F 3/04; B09C 1/00

(52) U.S. Cl. CPC E03F 1/003; C02F 3/046; B09C 1/002

(57) ABSTRACT

A Soil Absorption System SAS can include at least two elongate water dispersion trenches, channels or slots cut or formed into a surface or the ground, and filled with dispersal media, which can include stone. Each trench can be about 1-6 inches wide, about 4-48 inches deep, and laterally spaced a minimum of about 3-24 inches or about 3-12 inches apart from each other. This arrangement can provide increased lateral water dispersion surface area relative to lateral trench direction.

### RELATED APPLICATIONS

This application claims the benefit of U.S. Provisional Application No. 63/296,698, filed on Jan. 5, 2022. The entire teachings of the above application are incorporated herein by reference.

### BACKGROUND

Historic and/or traditional wastewater leaching facilities aka Soil Absorption Systems (SAS) typically utilized some combination of stone, pipe and masonry products to infiltrate wastewater into the surrounding soils. The earliest systems utilized open cisterns with surrounding stone and no prior settling, commonly referred to as cesspools. More modern systems utilize a water tight septic tank that settles solids and floats fats, oils and greases (FOG), thereby producing a weaker strength primary effluent which then flows to an SAS for infiltration into the ground. Traditional SAS's were most typically trenches, fields or galley systems that employed large construction equipment and large amounts of natural resources (stone, sand, etc) to create an SAS. Trenches typically are a series of parallel elongate leaching trenches filled with stone that are about 12-36 inches wide, about 24 inches deep, and are spaced a minimum of 2 times the greater of the trench height or width (24 to 48 inches). Leaching fields or beds are horizontally expansive areas of stone typically placed 6 to 12 inches deep. Galleys are systems that use a concrete, masonry or plastic structure with transmissible sides to create an open area that is surrounded by stone. All of these SAS types use pipe to introduce effluent into the leaching area. Construction any of these types of SAS's requires the use of large excavating equipment, a great quantity of natural resources and is generally expensive and disruptive to the site.

### SUMMARY

The present disclosure can include a Soil Absorption System (SAS) or wastewater infiltration system, which can include a water leaching field (or leaching trenches), and provides a method of forming an SAS that can be made using smaller equipment, in less time, with less site disruption and at a reduced cost than in the prior art. The present disclosure SAS can also cover less square footage or lateral area of land, soil, ground or surface than an equivalent SAS or leaching field in the prior art.

The SAS can include at least two elongate water dispersion trenches, channels or slots cut, dug or formed into a surface, soil or the ground, and filled with dispersal media, which can include stone. Each trench can be about 1-6 inches wide, about 4-48 inches deep, and laterally spaced a minimum of about 3-24 inches or about 3-12 inches apart from each other. This arrangement can provide increased lateral water dispersion surface area relative to lateral trench direction.

In particular embodiments, each trench can be less than 6 inches wide. In some embodiments, each trench can be about 1-4 inches wide, and in other embodiments, can be about 1-3 inches wide. In some embodiments, every foot in the lateral direction of the trenches in the SAS or leaching field can include at least two trenches. As a result, a series of narrow trenches can be laterally spaced closely together, resulting in a larger number of trenches that can be laterally spaced apart in a given area of land in contrast to prior trenches, thereby increasing lateral water dispersion surface area in comparison to the prior trenches for the same amount of land. This can provide an increased water dispersion surface area to lateral trench direction ratio, or to the square area of the surface or land. In some embodiments, each trench can be about 1-3 inches wide, about 6-24 inches deep, and laterally spaced about 3 or 9-24 inches apart from each other. In some embodiments, dispersal media can be positioned between and interconnect the at least two elongate water dispersion trenches together. In some embodiments, the at least two elongate water dispersion trenches can include at least two longitudinal trenches, and at least two transverse trenches that are transverse to and connect to the longitudinal trenches.

The present disclosure can also provide a Soil Absorption System (SAS) including at least two elongate water dispersion trenches cut, dug or formed into a surface and filled with dispersal media. Each trench can be about 1-3 inches wide, about 6-24 inches deep, and laterally spaced about 3-24 inches apart from each other for providing increased lateral water dispersion surface area relative to lateral trench direction.

The present disclosure can also provide a method of forming a SAS or water leaching field including cutting, digging or forming at least two elongate water dispersion trenches into a surface with a cutting blade or digging tool. Each trench can be filled with dispersal media. Each trench can be about 1-6 inches wide, about 4-48 inches deep, and laterally spaced a minimum of about 3-24 inches or about 3-12 inches apart from each other. Minimum trench spacing can be limited by soil characteristics and at the lower end of media size. This arrangement can provide increased lateral water dispersion surface area relative to lateral trench direction.

In particular embodiments, each trench can be cut with a width less than 6 inches wide. In some embodiments, each trench can be cut about 1-4 inches wide, and in other embodiments, about 1-3 inches wide. The trenches can be cut such that every foot in the lateral direction of the trenches in the leaching field can include at least two trenches. The trenches can be cut into the surface with one of a rotary cutting blade and a chain cutting blade. In some embodiments, dispersal media can be positioned between and interconnect the at least two elongate water dispersion trenches together. In some embodiments, the at least two elongate water dispersion trenches can include at least two longitudinal trenches and at least two transverse trenches that are transverse to and connect to the longitudinal trenches.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a cross-sectional view of an embodiment of a soil absorption system under construction in the present disclosure.

FIG. 2 is a plan view of another embodiment of a soil absorption system.

FIG. 3 is a side view of an embodiment of a trencher forming a trench.

FIG. 4 is a top view of an embodiment of a trencher forming a trench.

FIG. 5 is a plan view of another embodiment of a trencher.

FIG. 6 is a cross-sectional view of an embodiment of a soil absorption system.

FIG. 7 is a reference numeral chart for certain features in the figures.

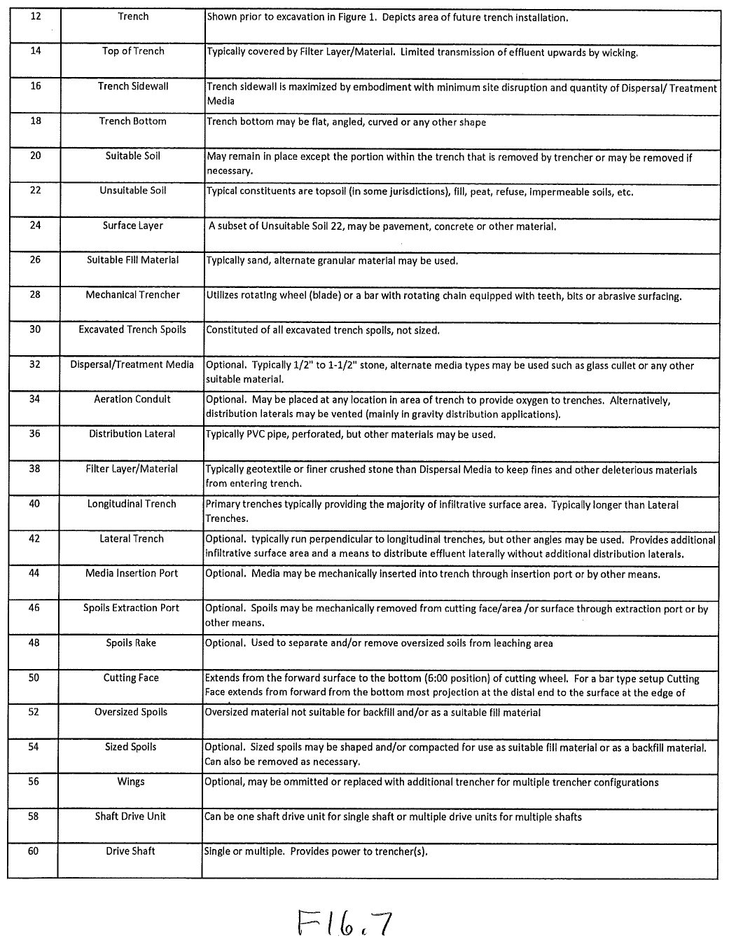

### DESCRIPTION

A description and drawings of example embodiments are attached.

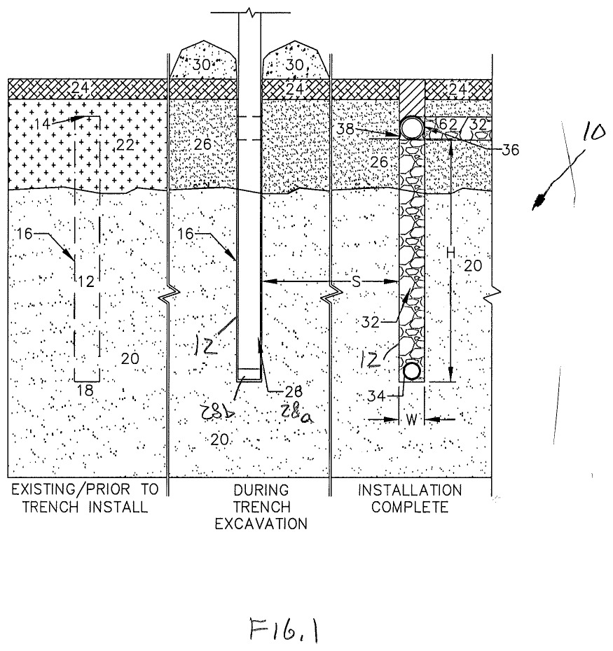

FIG. 1 depicts a cross-section of an embodiment of a Soil Absorption System (SAS) or wastewater infiltration or leaching field or system 10 under construction. Constructing system 10 can include mechanically removing soil from narrow trenches 12 with a mechanical trencher or trenching, cutting or digging apparatus 28, placing optional aeration conduits or lines 34 in trenches 12, placing aggregate or dispersal/treatment media or material 32 in the trenches 12, placing lateral distribution conduit or piping 36 in the trenches 12, and backfilling the trenches 12. FIG. 1 depicts a completed trench 12, a trench 12 during excavation, and a future trench location 12 (shown prior to material removal), showing the top location 14, effective depth or height H, width W, and spacing S. Each trench 12 can have lateral sidewalls 16 of depth H. The trench bottom 18 can also have the width W. Suitable ground or soil material 20 can remain in place. Unsuitable material 22 present and the surface layer 24, which may be asphalt, concrete, topsoil, etc., can be a subset of unsuitable material 22, and may be removed by standard methods, or to remain and be removed by mechanical trencher 28. If unsuitable material 22 and 24 is removed, suitable fill material 26 (typically sand) can be placed to bring the grade to the necessary elevation. Suitable fill material 26 can be compacted and moisture may be added to optimize the trench stability following excavation. Alternatively, unsuitable material 22 may be left in place and removed by the mechanical trencher 28. The top of the trench 14 can be at or below the bottom of unsuitable material 22. Although 3 locations of trenches 12 are shown, the number of trenches 12 can be any number suitable for the situation at hand.

The trencher 28 can utilize movable blade 28a such as a rotating or rotary blade, or a bar (can be considered a blade) with a guided rotating chain forming a chain blade (similar to a chainsaw), for cutting or digging. Both types of blades 28a can be fitted with cutting or digging teeth, bits or abrasive cutters 28b to cleanly remove material from a trench 12. A rotating blade trencher 28 typically can be powered by a shaft at the center of the blade 28a, which means that the power can come from behind the cutting edge of the trencher 28. A rotating chain type trencher 28 is typically powered by source that can be located in front of the cutting surface as the blade 28 is angled down away from the power source. The excavated trench wall 16 surface area can be maximized by excavation of narrow trenches 12 with trencher 28. Trench configuration may be in shapes other than the rectangular shape shown. Trench orientation may be vertical, perpendicular to the surface of the ground, or at any angle. Excavated spoils 30 extracted from trenches 12 can be removed from the cutting surface of blade 28a by mechanical means (vacuum or other), or deposited at the side of the trenches 12. In the case of where excavated spoils 30 consist solely of suitable material 20, spoils 30 may be spread, formed and compacted to form trench sidewalls 16, thereby reducing necessary trench excavation depth.

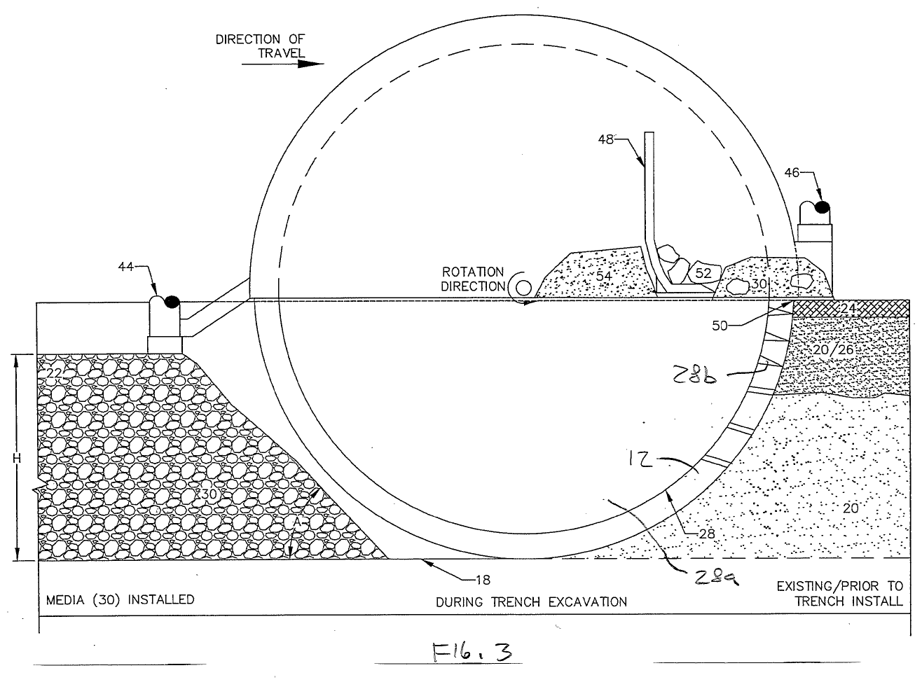

The cut trenches 12 can be filled with dispersal/treatment media 32 immediately following trench excavation to aid in trench stability. Dispersal media 32 is typically stone, but can be crushed glass, tire chips, or any other suitable media. Media 32 can typically be dense so as to fill the void space created by the trenching apparatus 28. Dispersal media 32 is typically placed mechanically following trench excavation through a media insertion port 44 (FIG. 3), but maybe placed by any other suitable means. An optional horizontal leaching surface having a dispersal media 32 layer can extend between the tops 14 of trenches 12 to provide additional downward facing infiltration surface area. Optional aeration conduit 34 may be placed in trenches 12 at or near the bottom 18 of trenches 12 or anywhere in contact with or in close proximity to trenches 12. Aeration conduit 34 may be vented passively, or actively vented by means of a mechanically induced pressure differential. Note aeration conduit 34 may be placed before, during or after the dispersal media 32. Perforated effluent or water distribution lateral conduits or pipes 36 can introduce liquid influent or water 36a to trenches 12 by pressure or gravity flow. Filter layer/material 38 can be placed at the top 14 of trenches 12 to prevent backfilled soils from migrating into the trenches 12. Filter layer/material 38 may be geotextile, crushed stone or other suitable material to prevent the migration of the undesired matter into the trenches 12. The number of trenches 12 can range from a single trench to any number (1-2, 1-3, 1-4, 1-10, 1-20, etc.) that site conditions necessitate and/or allow. Trenches 12 may be excavated installed one at a time, or multiple trenches 12 can be spaced side-by-side at specified intervals and installed in a single pass.

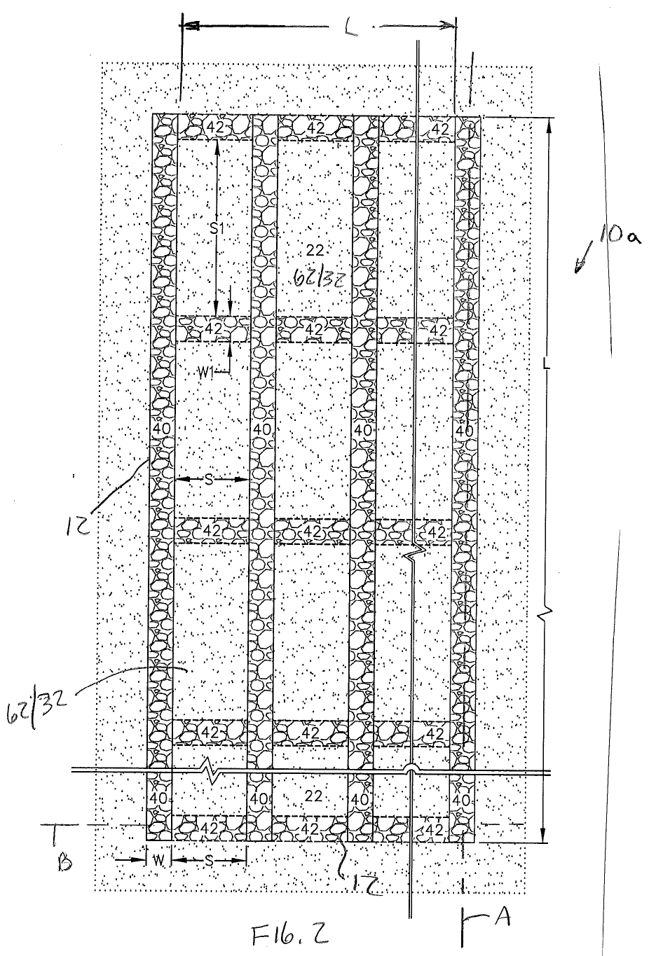

FIG. 2 depicts a top or plan view of an embodiment of a Soil Absorption System (SAS) or wastewater infiltration or leaching field or system 10a. System 10a can include multiple longitudinal trenches 40 (a version or subset of trenches 12) with a length L extending along respective longitudinal axes A, which can be 20 to 50 feet long and up to as much as 100 feet long, with pressure distribution. Trench width W can be typically 1-5 inches, though minimum width is limited primarily by dispersal media sizing and operational constraints. Spacing S is typically a minimum of two times trench width W. Soil conditions and trenching characteristics can be limiting factors of minimum trench spacing S. In some embodiments, greater spacing S is possible, however smaller spacing S tends to be more desirable as it allows for greater effective lateral leaching or infiltration surface area and a smaller footprint with less disturbed area. Trenches 40 may be formed or cut by means of a single trencher 28, one a time, or by means of a gang of trenching apparatuses, wheels or chains spaced at specified trench intervals, which allows for multiple trenches to be cut in a single pass. Optional transverse or lateral trenches 42 (versions or subset of trenches 12) with a length L extending along respective lateral axes B, can be cut in a similar manner to longitudinal trenches 40. Longitudinal trenches 40 can be cut and filled with dispersal media 32 prior to lateral trench installation. This can help maintain trench wall 16 integrity and stability. Lateral trenches 42 can provide increased infiltrative surface area as well as providing a means for lateral migration of water or effluent 36a to adjacent longitudinal trenches 40, thereby reducing the number of distribution pipes 36 required. Four longitudinal trenches 40 are shown equally spaced side-by-side, and five lateral trenches 42 are shown laterally or transversly interconnecting trenches 40 together. System 10a can have any number of trenches 40 and 42 as desired. Trenches 42 can be generally equally spaced, but depending upon the length of longitudinal trenches 40, can include a trench 42 at one end that is spaced closer to the adjacent trench 42. In some embodiments, horizontal leaching surfaces 62 consisting of a layer of dispersal media 32 can be positioned between and interconnect trenches 12/40/42 for increasing effluent or water 36a infiltration surface area and dispersion.

FIG. 3 depicts a side profile view of an embodiment of a trencher 28 in the present disclosure during operation. After unsuitable material 22 is removed, suitable fill material 20 can be placed and compacted as necessary to facilitate cutting of a trench 12 by mechanical trencher 28. Alternatively, unsuitable material 22 media can be left in place and removed by the mechanical trencher 28. The mechanical trencher 28 can utilize a rotating blade (shown) or a bar with a chain to remove both unsuitable material 22 and suitable material 20 from trench 12. Precise narrow trenches 12 can be created providing maximum surface area for infiltration. Excavated trench sidewall 16 surface area can be maximized by excavation or cutting of closely spaced narrow trenches 12 with the trencher 28. Excavated spoils 30 can be removed from trench 12 by a suction induced draft from the cutting face 50 through the spoils extraction port 46. Alternatively, spoils 30 may be left on the surface side of the trench 12. An adjustable (vertical, horizontal, and angular) spoils deflector may be used to direct spoils 30 as desired. Dispersal media 32 can be placed in the excavated trench 12 via a media insertion port 44 which can be located above or within the trench 12. Media 32 can be supplied to the media insertion port 44 by mechanical means such as forced air, auger, conveyor, etc. Media 32 may also be placed manually after trench 12 is cut. Trench excavation and placement of media 32 can occur simultaneously or on several passes to allow for insertion of aeration conduit 34 if desired. Longitudinal trenches 12/40 can be filled with dispersal media 32 typically stone but crushed glass, tire chips or any other suitable material may be used. Optional aeration conduit 34 may be placed in the trenches 12/40 at or near or in contact with the bottom 18 of trenches 12/40. Aeration conduit 34 may be vented passively or airflow can be mechanically induced (pressure/vacuum). Aeration conduit 34 may be placed before, during or after dispersal media 32. Effluent or water 36a can be introduced to perforated effluent distribution laterals, pipes or conduits 36 by pressure or gravity flow. Filter layer/material 38 can be placed at the top 14 of trenches 12 to prevent the migration of soils into trenches 12. Filter layer 38 can consist of geotextile fabric or other suitable material. The number of trenches 12 can range from a single trench 12 to any number that site conditions allow and/or necessitate. A spoils rake 48 can comprise vertical bars to separate oversized rock material from the spoils pile. The spoils rake 48 may have forward projecting horizontal bars to carry oversized materials to the end of the trenches 12.

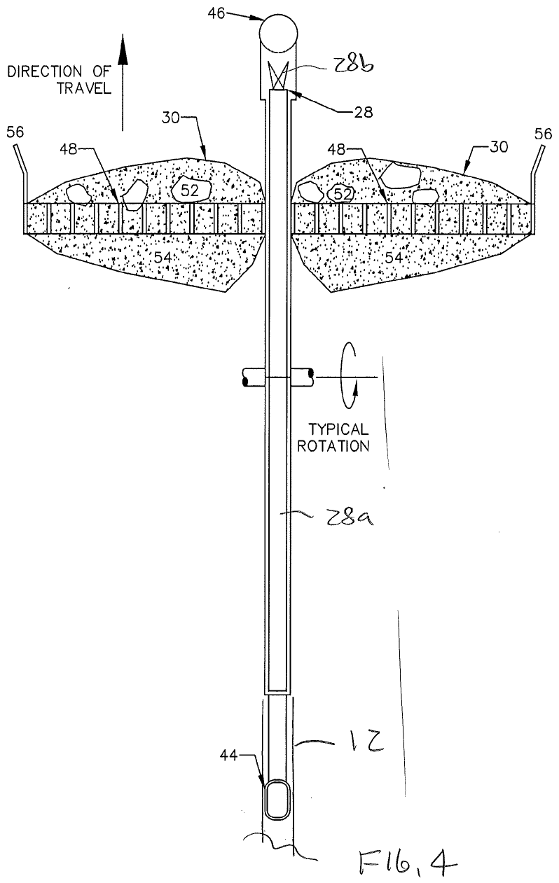

FIG. 4 depicts a top or plan view of an embodiment of a mechanical trencher 28 in the present disclosure. Mechanical trencher 28 can include a spoils rake 48. Spoil 30 consisting of soil and rocks of varying sizes can be either removed from the front side of trencher 28 through the spoils extraction port 46, or left outside of trench 12. Oversized spoils 52 can be separated from spoils 30 left at the side of the trench 12 by passing the spoils rake 48 through the spoils 30. Sized spoils 54 suitable to be used adjacent to trenches 12 may be produced. Outer wings 56 of rake 48 may be utilized to contain the spoils 30. Oversized spoils 52 may be either pushed or dumped at the extremities of the trenches 12.

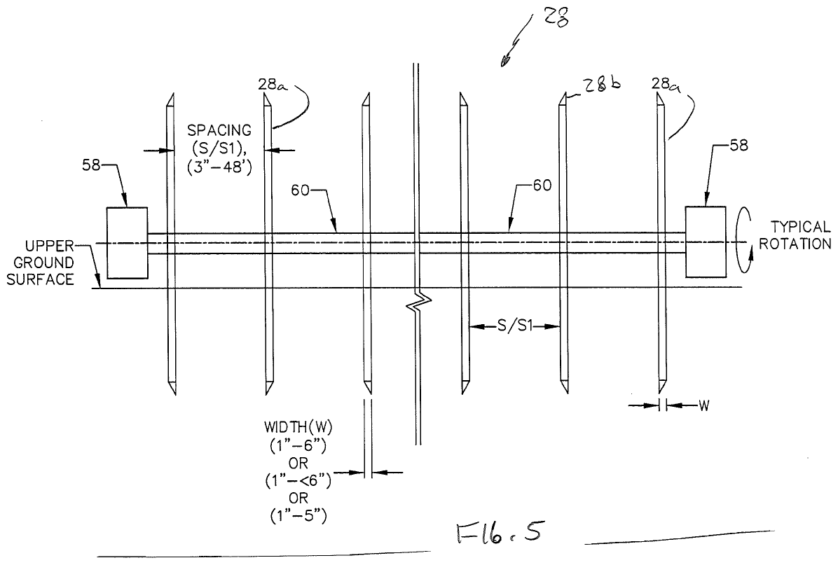

FIG. 5 depicts a top or plan view of another embodiment of a mechanical trencher 28 in the present disclosure, showing multiple trencher blades 28a in a gang configuration. Blades 28a can be rotary saw or chained blades. A mechanical trencher 28 in a gang (multiple) blade configuration, can employ all the same features previously described. Trencher blades 28a can be spaced at specified intervals (S/S1) to achieve desired trench spacing for both the longitudinal and lateral trenches (40 and 42). Shaft drive units 58 can power driveshafts 60 which turn the trencher blades 28a. A single or multiple shaft drive units 58 can be located at the end and/or between trencher blades 28a, and multiple driveshafts 60 may be utilized. The trencher blades 28a can be the same width as the desired trenches 12, for example about 1-6 inches, about 1 to leas than 6 inches, about 1-5 inches, about 1-4 inches, or about 1-3 inches.

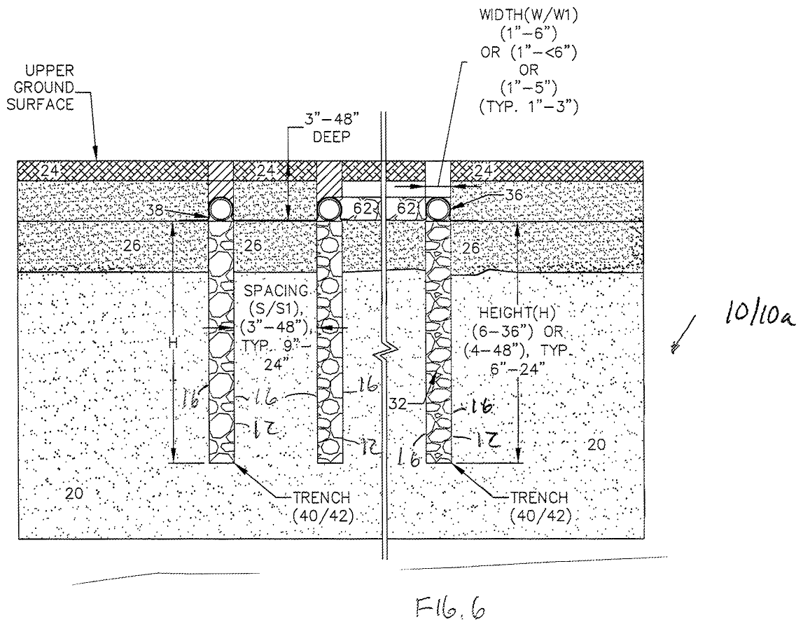

FIG. 6 depicts a cross-sectional view of an embodiment of a Soil Absorption System (SAS) 10 or 10a in the present disclosure, with multiple trenches 12 shown. Suitable material 20, surface layer 24, suitable fill material 26 and dispersal/treatment media 32 are shown. Perforated effluent or water distribution lateral pipes or conduits 36 can introduce water or effluent 36a to trenches 12 by pressure of gravity flow. Filter layer/material 38 may be extended continuously over the entire trench area or individual sections, and may cover the area above and around each trench 12. Trenches 12 can be about 3-48 inches below the surface layer 24. Wall-to-wall spacing (S/S1) of the trench sidewalls 16 is typically about 3-48 inches, about 9-24 inches, about 3-24 inches, or about 3-12 inches, but may be greater than 48 inches. However more compact spacing is preferable for increased infiltrative surface area. If horizontal leaching area 62 is included, filter layer material 38 can be placed above it. Surface layer 24 can be removed and replaced as necessary.

In some embodiments, the trenches 12 can have a width W that is about 1-6 inches wide, about 1 to less than 6 inches wide, about 1-5 inches wide, about 1-4 inches wide, or about 1-3 inches wide. Trenches 12 can have a height H (or depth) that is about 4-48 inches, about 6-36 inches, or about 6-24 inches. In some embodiments, each trench 12 can be about 1-3 inches wide, about 6-24 inches deep and laterally spaced about 3 or 9-24 inches apart from each other. In one example, each trench 12 can be about 1 inch wide W, about 48 inches high H and spaced about 3 inches S apart. This can result in three 1 inch wide trenches 12 laterally spaced apart from each other within a 12 inch lateral distance, and provide six trench sidewalls 16 that have lateral surface contact with the surrounding soil 20 for laterally leaching or delivering effluent or water 36a to the surrounding soil 20. For a 1 foot long by 1 foot wide section of such trenches 12, this can provide 24 ft.² of lateral water dispersing surface area. For such spacing, 18 trench sidewalls 16 can also be provided within a 35 inch lateral distance. In contrast in the prior art, the narrowest trenches are typically 12 inches wide, 24 inches deep, and spaced 24 inches apart, providing only two trench sidewalls that have lateral surface contact area with surrounding soil within a 35 inch-wide lateral distance, and therefore much less lateral effluent or water dispersing surface area. A 1 foot long by 35 inch-wide section of such trenches in the prior art would only provide about 4 ft.² of lateral effluent or water dispersing area. Consequently, embodiments of the soil absorption system (SAS) 10 and 10a can have a series of trenches 12 that are narrower and more closely spaced together than in the prior art. This can increase lateral effluent or water 36a dispersion surface area in comparison to prior trenches for the same amount of land, in the direction that is lateral to the longitudinal direction of trenches 12. This provides increased water or effluent 36a dispersion surface area to lateral trench direction ratio, or to the square area of the surface, ground or land. The trenches 12 can be sized and spaced such that every foot (12 inches) in the lateral direction to the trenches 12 in SAS 10 or 10a can include at least two trenches 12, thereby providing four trench sidewalls 16 that have lateral surface contact with surrounding soil 20. 6 inch wide W trenches 12 spaced 24 inches apart S can provide three trench sidewalls 16 within a 35 inch wide lateral distance, which can also provide greater lateral surface area than in the prior art.

The narrow trenches 12 in the present disclosure can be cut or dug with much smaller equipment than the excavators typically used in the prior art. The use of rotary cutting blades 28a allows narrow trenches 12 to be cut cleanly into the soil without collapsing, and quickly formed. In addition, the narrow trenches 12 require much less dispersal media 32, and can be filled more quickly. Consequently, labor and material costs for systems 10 and 10a can be reduced in comparison with prior art systems.

While example embodiments have been particularly shown and described, it will be understood by those skilled in the art that various changes in form and details may be made therein without departing from the scope of the embodiments encompassed by the appended claims. For example, various features shown and described can be omitted or combined together. In addition, various dimensions can vary depending upon the situation at hand.

What is claimed is:

1. A Soil Absorption System (SAS) comprising:
at least two elongate water dispersion trenches cut into a surface and filled with dispersal media, each trench being about 1-6 inches wide, about 4-48 inches deep, and laterally spaced about 3-24 inches apart from each other for providing increased lateral water dispersion surface area relative to lateral trench direction.

2. The system of claim 1 in which each trench is less than 6 inches wide.

3. The system of claim 2 in which each trench is about 1-4 inches wide.

4. The system of claim 3 in which each trench is about 1-3 inches wide.

5. The system of claim 4 in which every foot in the lateral direction of the trenches in the SAS includes at least two trenches.

6. The system of claim 1 further comprising dispersal media positioned between and interconnecting the at least two elongate water dispersion trenches together.

7. The system of claim 6 in which the at least two elongate water dispenser trenches include at least two longitudinal trenches and at least two transverse trenches that are transverse to and connect to the longitudinal trenches.

8. A Soil Absorption System (SAS) comprising:
at least two elongate water dispersion trenches cut into a surface and filled with dispersal media, each trench being about 1-3 inches wide, about 6-24 inches deep, and laterally spaced about 3-24 inches apart from each other for providing increased lateral water dispersion surface area relative to lateral trench direction.

9. A method of forming a Soil Absorption System (SAS) comprising:
cutting at least two elongate water dispersion trenches into a surface with a cutting blade; and
filling each trench with dispersal media, each trench being about 1-6 inches wide, about 4-48 inches deep, and laterally spaced about 3-24 inches apart from each other, for providing increased lateral water dispersion surface area relative to lateral trench direction.

10. The method of claim 9 further comprising cutting each trench less than 6 inches wide.

11. The method of claim 10 further comprising cutting each trench about 1-4 inches wide.

12. The method of claim 11 further comprising cutting each trench about 1-3 inches wide.

13. The method of claim 12 further comprising cutting the trenches such that every foot in the lateral direction of the trenches in the SAS includes at least two trenches.

14. The method of claim 9 further comprising cutting the trenches into the surface with one of a rotary cutting blade and/or a chain cutting blade.

15. The method of claim 9 further comprising positioning dispersal media between and interconnecting the at least two elongate water dispersion trenches together.

16. The method of claim 15 in which the at least two elongate water dispersion trenches include at least two longitudinal trenches and at least two transverse trenches that are transverse to and connect to the longitudinal trenches.
